(19) United States
(12) Patent Application Publication
(10) Pub. No.: US 2024/0084925 A1
(43) Pub. Date: Mar. 14, 2024

(54) Strain Relief Assembly

(71) Applicant: Belden Canada ULC, Saint-Laurent (CA)

(72) Inventors: Christian Roa-Quispe, Laval (CA); Oscar Alberto Lazarte Barrios, Saint-Laurent (CA)

(21) Appl. No.: 18/519,372

(22) Filed: Nov. 27, 2023

Related U.S. Application Data
(63) Continuation of application No. 17/650,829, filed on Feb. 11, 2022, now Pat. No. 11,835,163.
(60) Provisional application No. 63/200,081, filed on Feb. 12, 2021.

(51) Int. Cl. F16L 3/01

(52) U.S. Cl. CPC F16L 3/01

(57) ABSTRACT

A strain relief assembly comprising a support portion including a base portion, a first portion coupled with the base portion, and a second portion extending away from an end of the first portion, a strain relief portion attached to a free end of the second portion for rotation about an axis, a securing portion that moves relative to the strain relief portion between a secured position and a released position. The strain relief portion comprises a cable receiving portion arranged along the axis. The securing portion disables rotation of the strain relief member about the axis when in the secured position and enables rotation of the strain relief member about the axis when in the released position. The strain relief portion rotates about the axis between a first angled orientation and a second angled orientation through a horizontal orientation so as to enhance management of fiber optic-cables in high-density applications.

### CROSS REFERENCE TO RELATED APPLICATIONS

This application is a continuation of U.S. application Ser. No. 17/650,829 filed on Feb. 11, 2022 which claims benefit under 35 U.S.C. § 119(e) of U.S. provisional application Ser. No. 63/200,081 filed on Feb. 12, 2021. Both these documents are incorporated herein in their entirety by reference.

### FIELD OF THE INVENTION

The present invention relates to a strain relief assembly. In particular, the present invention relates to an adjustable strain relief assembly mountable to a tray.

### SUMMARY OF THE INVENTION

There is provided a strain relief assembly, comprising a support portion structurally configured to include a base portion, a first portion coupled with the base portion, and a second portion extending away from an end of the first portion, a strain relief portion structurally configured to attach to a free end of the second portion for rotation about an axis, a securing portion structurally configured to move relative to the strain relief portion between a secured position and a released position, wherein the strain relief portion comprises a cable receiving portion arranged along the axis. The securing portion is structurally configured to disable rotation of the strain relief member about the axis in the secured position. The securing portion is structurally configured to enable rotation of the strain relief member about the axis in the released position. The strain relief portion is structurally configured to rotate about the axis between a first angled orientation and a second angled orientation through a horizontal orientation so as to enhance management of fiber optic-cables in high-density applications.

There is also provided a strain relief assembly, comprising a support member, a strain relief member, a securing mechanism. The strain relief member is attached to a free end of the support member for rotation about an axis. The strain relief member comprises a cable receiving portion arranged along the axis and a cable receiving surface. The securing mechanism is configured to move between a secured position and a released position. In the secured position rotation of the strain relief member about the axis is disabled.

Furthermore, there is provided a device for preventing a strain relief member from rotating during operation comprising a strain relief member that is configured to rotate about an axis, the strain relief member comprising a cable receiving portion that extends along the axis, and a strain relief securing portion that is configured to prevent rotation of the strain relief member about the axis during operation of the strain relief member.

### BRIEF DESCRIPTION OF THE DRAWINGS

FIG. 1 provides a raised perspective view of a strain relief assembly and tray in accordance with an illustrative embodiment of the present invention;

FIG. 2 provides a raised exploded perspective view of strain relief assembly in accordance with an illustrative embodiment of the present invention;

FIG. 3 provides a sectional view along III-Ill in FIG. 1;

FIGS. 4A through 4C provide sectional views along IV-IV in FIG. 1; and

FIGS. 5A through 5C provide front perspective views of a strain relief assembly and tray receiving cables from different orientations and in accordance with an illustrative embodiment of the present invention.

### DETAILED DESCRIPTION OF THE ILLUSTRATIVE EMBODIMENTS

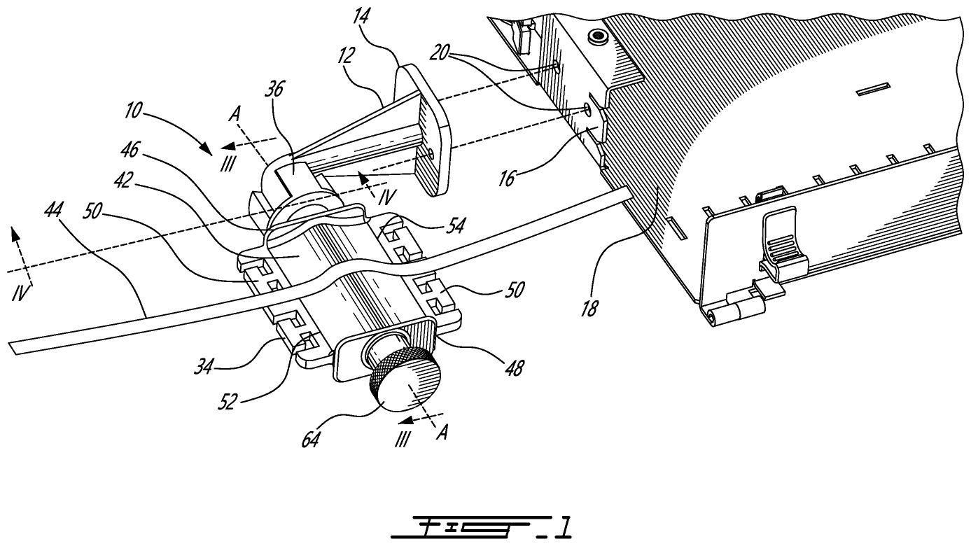

Referring now to FIG. 1, a strain relief assembly, generally referred to using the reference numeral 10, will now be described. The assembly 10 comprise a support 12 comprising a flat base 14 configured for attachment to a flat surface, such as the side 16 of a tray 18 or the like. In this regard, the flat base 14 can be secured to the side 16 using bolts or the like (not shown) which are engaged in complementary threaded bores 20 machined or otherwise formed in the side 16.

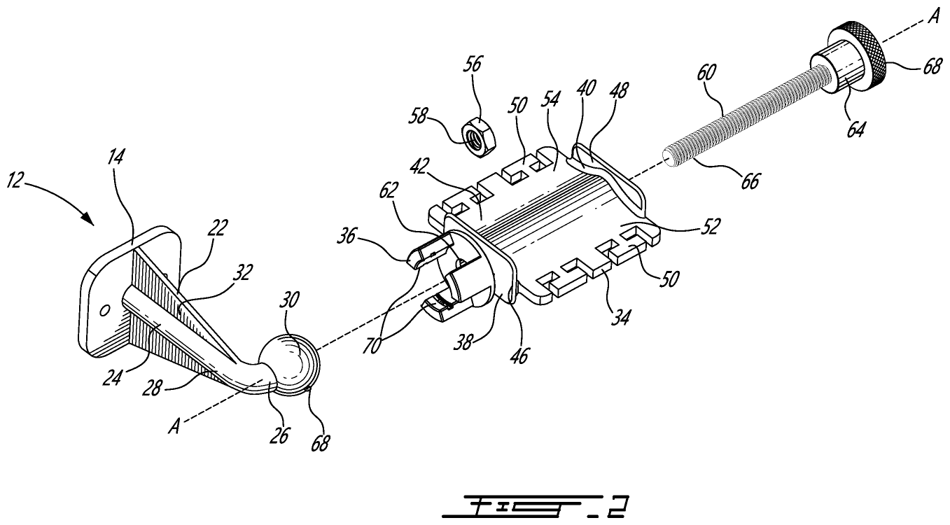

With reference now to FIG. 2 in addition to FIG. 1, the support 12 further comprises an elongate support member 22 comprising a rod-like first portion 24 attached to the base 14 and extending away therefrom in a direction which is substantially normal to the base 14 and a second portion 26 arranged at a right angle to the first portion 24 and interconnecting an outer end 28 of the first portion with a spherical ball 30. In a particular embodiment the second portion 26 is curved about 90 degrees between the outer end 28 and the ball 30. Re-enforcing abutments 32 are provided to stabilise the support member 22.

Still referring to FIG. 2 in addition to FIG. 1, the strain relief assembly 10 further comprises an elongate strain relief member 34 comprising a socket 36 at a first end 38 and configured for receiving the ball 30 in a ball and socket relationship and for limited rotation about an axis A-A. The strain relief member 34 further comprises an elongate cable receiving part 40 arranged along the axis A-A. The cable receiving part 40 further comprises a pair of cable receiving surfaces 42 of like shape and opposite one another on either side of the axis A-A for receiving cables 44 thereon. In order to retain the cables 44 on the surfaces 42 first and second collars 46, 48 are provided at respective ends of the cable receiving part 40. Similarly, cable securing features 50 are provided along a length of the outer long edges 52, 54 of the cable receiving part 40. In this regard the cable securing features 50 provide convenient locations for securing cable ties or the like (not shown).

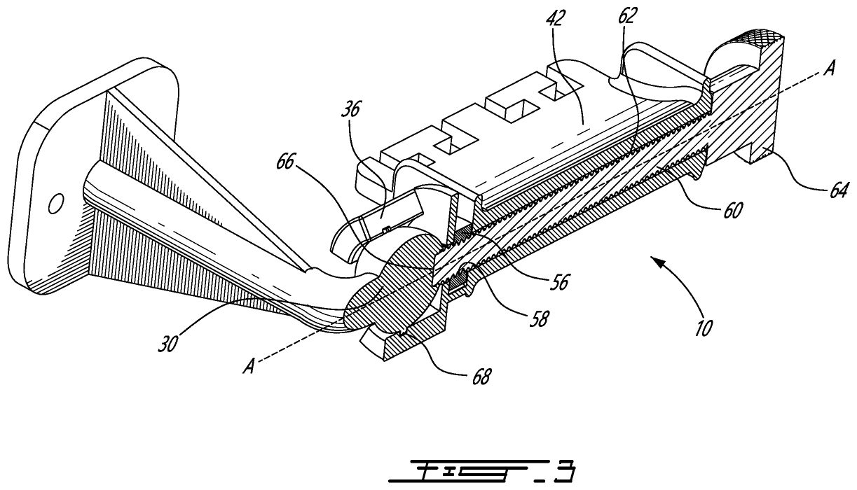

Referring now to FIG. 3 in addition to FIGS. 1 and 2, in order to releasably secure the ball 30 and socket 36 in a fixed relationship a securing mechanism is provided comprising a bolt 56 embedded in the cable receiving part 40. The bolt 56 comprises a threaded inner surface 58 arranged concentric with the axis A-A which engages a threaded shaft 60. The shaft 60 is held for rotation within a shaft receiving bore 62 arranged concentric with the axis A-A and further comprises a user actuatable knob 64. As a person of skill in the art will now understand, depending on the direction the knob 64 is turned, an end 66 of the shaft 60 may be selectively moved towards or away from the ball 30 held within the socket 36. Moving the shaft 60 towards the ball 30 causes the end 66 to engage the ball 30 thereby releasably secures the ball 30 in a fixed relationship to the socket 36.

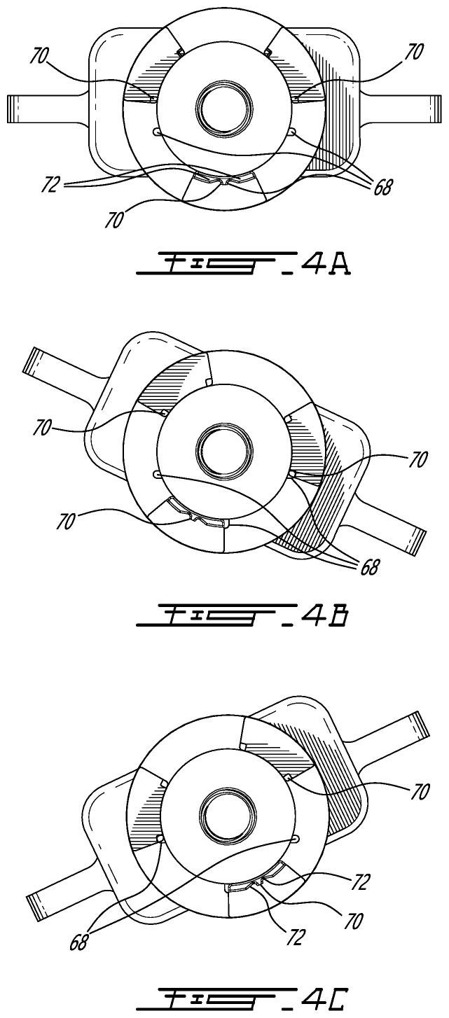

Referring to FIG. 4A in addition to FIGS. 2 and 3, releasing the engagement between the support 12 and the cable receiving part 40 by rotating the knob 64 allows the cable receiving part 40 to be rotated relative to the support 12. In this regard, the ball 30 comprises bosses 68 which engage with features 70 on the socket 36 in order to limit rotation of the cable receiving part 40 to the support 12 to within predetermined limits. In an intermediate position as shown in FIG. 4A a middle one of the bosses 68 is received within the lower feature 70. In this regard the lower feature 70 comprises bevelled walls 72 such that the boss 68 can be moved in to and out of the feature 70 while providing tactile feedback.

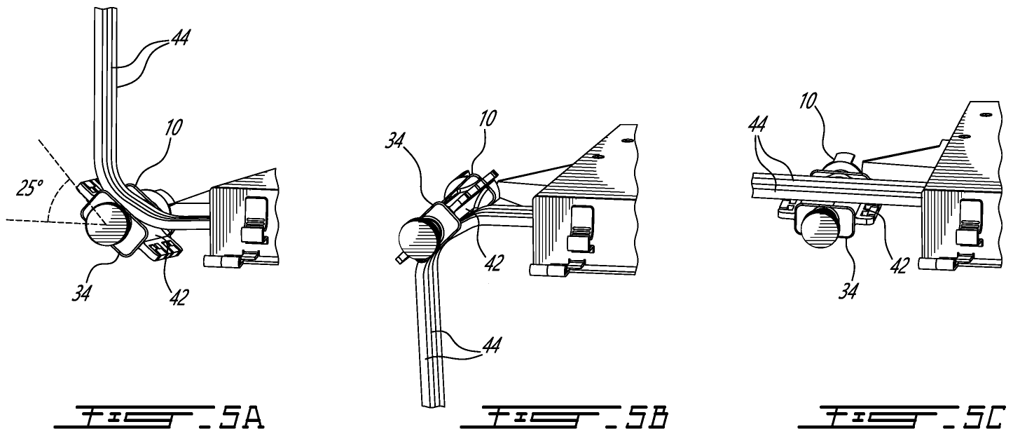

Referring to FIGS. 5A through 5C, illustratively the bosses 68 and features 70 are positioned such that the strain relief member 34 can be rotated through 50° and the cable receiving surfaces 42 positioned at up to ±25° from the horizontal. This allows cables 44 to be conveniently received and secured from above (FIG. 5A), below (FIG. 5B) and the side (FIG. 5C) as well as intermediate positions.

Although the present invention has been described hereinabove by way of specific embodiments thereof, it can be modified, without departing from the spirit and nature of the subject invention as defined in the appended claims.

1. A strain relief assembly, comprising:
a support portion structurally configured to include a base portion, a first portion coupled with the base portion, and a second portion extending away from an end of the first portion;
a strain relief portion structurally configured to attach to a free end of the second portion for rotation about an axis;
a securing portion structurally configured to move relative to the strain relief portion between a secured position and a released position;
wherein the strain relief portion comprises a cable receiving portion arranged along the axis;
wherein the securing portion is structurally configured to disable rotation of the strain relief member about the axis in the secured position;
wherein the securing portion is structurally configured to enable rotation of the strain relief member about the axis in the released position; and
wherein the strain relief portion is structurally configured to rotate about the axis between a first angled orientation and a second angled orientation through a horizontal orientation so as to enhance management of fiber optic-cables in high-density applications.

2. The assembly of claim 1, wherein a mechanical feedback is provided as the strain relief member is rotated into the horizontal orientation.

3. The assembly of claim 1, wherein an angle between the first angled orientation and the second angled orientation is less than or equal to 50 degrees.

4. The assembly of claim 2, wherein the mechanical feedback is provided by a boss on the free end of the second portion that is engaged in a feature on the strain relief member as the strain relief member is rotated into the horizontal orientation.

5. The assembly of claim 1, wherein the strain relief member further comprises a shaft receiving bore concentric with the axis and extending a length of the strain relief member and wherein the securing mechanism comprises a shaft configured for travel within the shaft receiving bore between the secured position and the released position.

6. The assembly of claim 5, wherein in the secured position a first shaft end of the shaft presses against the free end of the second portion thereby disabling rotation of the strain relief member about the axis, and wherein in the released position the shaft is positioned away from the free end of the second portion and such that rotation of the strain relief member about the axis is enabled.

7. The assembly of claim 5, further comprising a nut comprising a threaded inner surface imbedded in the strain relief member concentric with the axis, wherein a second shaft end extends beyond the elongate strain relief member and comprises a knob attached to the second shaft for rotating the shaft about the axis, wherein a complementary threaded portion of the shaft is engaged by the threaded inner surface of the nut and such that through rotation of the shaft using the knob, a threaded outer surface is engaged by the threaded inner surface thereby moving the first shaft end along the axis between the secured position and the released position.

8. A strain relief assembly, comprising:
a support member;
a strain relief member;
a securing mechanism;
wherein the strain relief member is attached to a free end of the support member for rotation about an axis;
wherein the strain relief member comprises a cable receiving portion arranged along the axis and a cable receiving surface;
wherein the securing mechanism is configured to move between a secured position and a released position; and
wherein in the secured position rotation of the strain relief member about the axis is disabled.

9. The assembly of claim 8, wherein the support member comprises a base, a first portion attached to the base and a second portion extending away from an end of the first portion and wherein the strain relief member is attached to a free end of the second portion for rotation about the axis.

10. The assembly of claim 8, wherein the strain relief member further comprises a shaft receiving bore concentric with the axis and extending a length of the strain relief member and wherein the securing mechanism comprises a shaft configured for travel within the shaft receiving bore between the secured position and the released position.

11. The assembly of claim 9, wherein in the secured position a first shaft end of the shaft presses against the free end of the second portion thereby disabling rotation of the strain relief member about the axis, and wherein in the released position the shaft is positioned away from the free end of the second portion and such that rotation of the strain relief member about the axis is enabled.

12. The assembly of claim 9, further comprising a nut comprising a threaded inner surface imbedded in the strain relief member concentric with the axis, wherein a second shaft end extends beyond the elongate strain relief member and comprises a knob attached to the second shaft for rotating the shaft about the axis, wherein a complementary threaded portion of the shaft is engaged by the threaded inner surface of the nut and such that through rotation of the shaft using the knob, a threaded outer surface is engaged by the threaded inner surface thereby moving the first shaft end along the axis between the secured position and the released position.

13. The assembly of claim 8, wherein the strain relief member is configured for rotation between a first angled orientation and a second angled orientation through a horizontal orientation.

14. The assembly of claim 13, wherein an angle between the first angled orientation and the second angled orientation is less than or equal to 50 degrees.

15. A device for preventing a strain relief member from rotating during operation comprising:
a strain relief member that is configured to rotate about an axis, the strain relief member comprising a cable receiving portion that extends along the axis; and
a strain relief securing portion that is configured to prevent rotation of the strain relief member about the axis during operation of the strain relief member.

16. The assembly of claim 15, further comprising a support member comprising a base and a first portion attached to the base and a second portion extending away from an end of the first portion and wherein the strain relief member is attached to a free end of the second portion for rotation about the axis.

17. The assembly of claim 16, wherein the second portion extends away from the first portion at a right angle to the first portion.

18. The assembly of claim 16, wherein the free end of the second portion comprises a ball and the strain relief member further comprises a socket concentric with the axis for receiving the ball.

19. The assembly of claim 15, wherein the cable receiving portion comprises a first cable receiving surface.

20. The assembly of claim 19, wherein the cable receiving portion comprises a second cable receiving surface on an opposite side of the axis to the first cable receiving surface.

21. The assembly of claim 20, wherein the cable receiving surface and the second cable receiving surface are like surfaces and arranged opposite one another about the axis.

22. The assembly of claim 15, wherein the cable receiving part further comprises a pair of long outer edges arranged opposite one another on either side of and in parallel to the axis, each the outer edges comprising a cable securing feature along a length thereof.
